(19) United States
(12) Patent Application Publication
(10) Pub. No.: US 2010/0143614 A1
(43) Pub. Date: Jun. 10, 2010

(54) Holiday and event bubble wrap

(76) Inventor: Christopher Holodny, Lakewood, CO (US)

Correspondence Address: RUTH EURE, 4795 EDISON AVENUE, BOULDER, CO, 80301, US

(21) Appl. No.: 12/592,250

(22) Filed: Nov. 20, 2009

Related U.S. Application Data
(60) Provisional application No. 61/116,524, filed on Nov. 20, 2008.

(51) Int. Cl. G09F 19/00; B32B 3/12; B28B 11/06

(52) U.S. Cl. 428/7; 428/178; 264/131

(57) ABSTRACT

The bubble wrap of the present invention includes glitter or confetti, or both encapsulated into the bubbles of the bubble wrap and embedded between the layers of film. One or both layers of plastic which comprise the bubble wrap can be colored, or printed to accentuate the holiday or event being celebrated. A method for making the bubble wrap is also provided.

### CLAIM OF PRIORITY

This patent application claims priority under 35 USC 119 (e) (1) from U.S. Provisional Patent Application Ser. No. 61/116,524 filed Nov. 20, 2008, of common inventorship herewith entitled, “Holiday and Event Bubble Wrap.”

### FIELD OF THE INVENTION

The present invention pertains to the field of wrapping for packages and more specifically to the filed of bubble wrap, and even more specifically to the appeal and decorative aspects of using bubble wrap while packaging gifts and merchandise for all holidays and special events.

### BACKGROUND OF THE INVENTION

The prior art has put forth several designs for bubble wrap. Among these are:

U.S. Pat. No. 6,038,834 to Tedford E. Haley describes Film Bubble Wrap Interleaf which comprises a method for protecting a roll of pressure sensitive paper and a package produced by the method using bubble wrap and film to protect the roll of paper.

U.S. Pat. No. 5,030,501 to David P. Colvin and Craig S. Potter describes a cushioning structure comprising one or more planar sheets of pliable material bonded to a matrix of polygon shape cells containing a fluid such as air or gas.

U.S. Pat. No. 4,869,939 to Philip J. Santo describes interactive air encapsulating cellular material in which failure due to the rupture of individual ones of the cells there of is substantially prevented.

U.S. Pat. No. 4,427,474 to Gary W, Ottaviano describes a method and apparatus for making an air cell cushioning product.

None of these prior art references describe the present invention.

### SUMMARY OF THE INVENTION

It is an object of the present invention to provide an improved method, apparatus and product comprising bubble wrap made of colorful designs including holiday, seasonal and event designs.

It is a further object of the present invention to provide an improved method, apparatus and product comprising bubble wrap, which incorporates confetti, glitter or other decorative material inside the bubbles of the bubble wrap.

It is a further object of the present invention to provide an improved method, apparatus and product comprising bubble wrap, which incorporates confetti, glitter or other decorative material inside the bubbles of the bubble wrap as well as confetti or glitter, or both embedded between the layers of plastic film which comprise the bubble wrap.

It is a further object of the present invention to provide an improved bubble wrap which incorporates colored or printed layer of plastic film.

Since the conception of bubble wrap it has remained a casual and conservative product designed to provide enhanced protection for products off all nature to be shipped, stored, and presented without any unnecessary damage. The present invention provides an enhanced improvement to bubble wrap. The present invention hereinafter referred to as Holiday and Event Bubble Wrap is designed for the packaging of gifts and other objects for holidays and special events, giving the gift a more appealing and special packaging. It can be manufactured as a clear, transparent, printed or colored bubble wrap with confetti, glitter or other decorative material injected into the air pocket bubbles of the bubble wrap so that the individual is able to see the glitter or confetti representing their specific event. The confetti, glitter or other decorative material is loose inside the bubbles of the bubble wrap as well as embedded between the layers of plastic film which comprise the bubble wrap.

Examples of confetti or decorative material include, but are not limited to: Valentines Day, bubble wrap with tiny pieces of confetti shaped like hearts, “x” and “o”s, little cupids etc. The pieces vary in size and color to be appealing. Christmas wrap includes tiny Christmas tress, sleds, reindeer, wreaths, Santa, etc. For Hanukkah, the pieces can include a dredle, a menorah, Star of David, etc.

### BRIEF DESCRIPTION OF THE DRAWINGS

FIG. 1 is schematic view of an apparatus for injecting confetti or glitter or other decorative material into the air pockets of the bubble wrap.

FIG. 2 depicts examples of confetti for inclusion into the bubbles and between the layers of the bubble wrap.

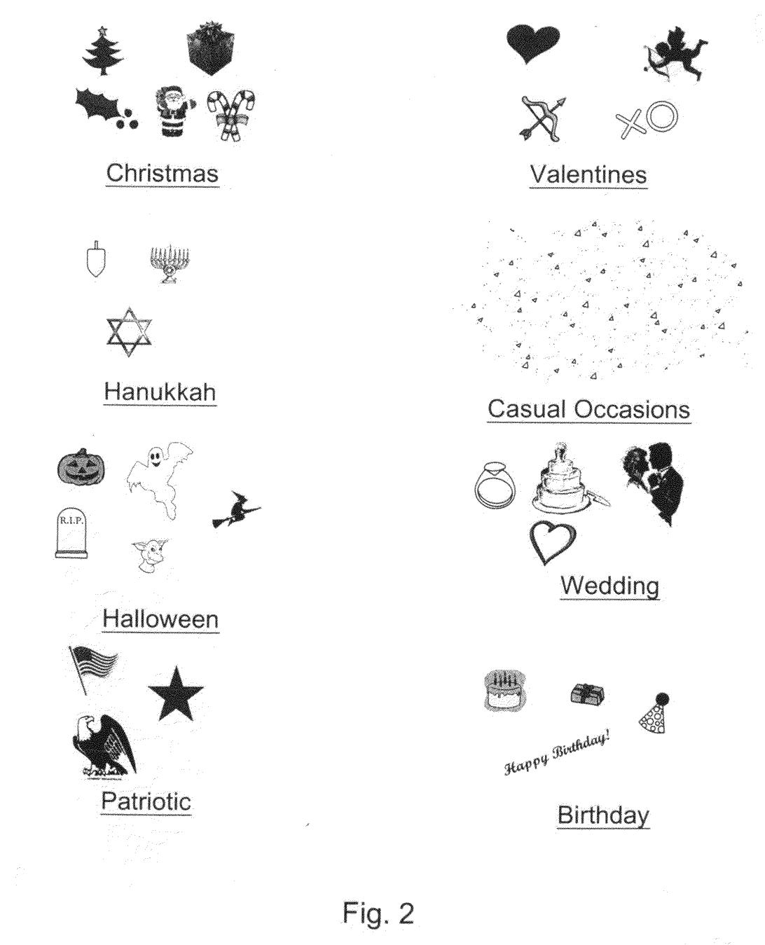

### DETAILED DESCRIPTION OF THE INVENTION

The present invention will become more fully understood from the detailed description given hereinbelow and the accompanied drawing which is given by illustration only, and thus is not limitative of the present invention, and herein:

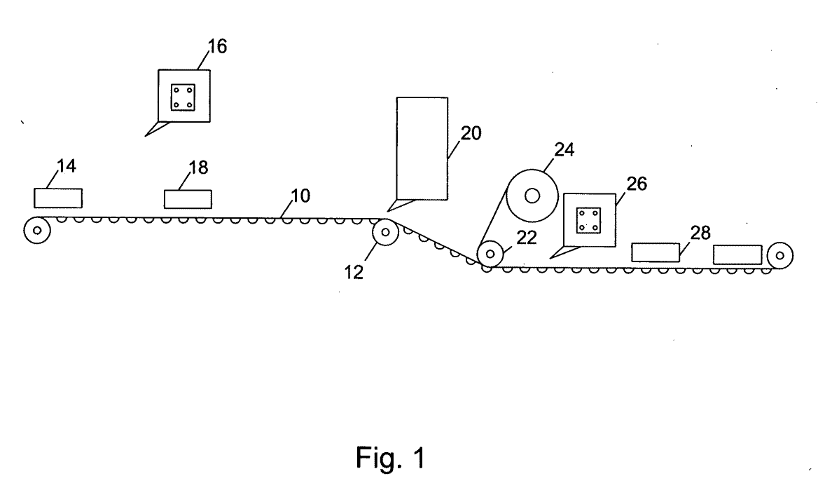

FIG. 1 is the side view of the device to manufacture Holiday and Event bubble wrap from the initial phase of the bubble wrap to just prior of the rolling and packaging phase.

The continuous nonstick conveyer belt 10 (forming belt) with thousands of indentations which will ultimately form the bubble head is supported by several soft foam support wheels 12 throughout the process. The manufacturing begins with the initial cooling system 14 as the conveyer begins through the system lowering the temperature of the belt to expedite the solidifying of the molten plastic being dispensed evenly over the width of the forming belt from the molten plastic film dispenser 16. Directly after the belt 10 is coated by molten plastic film it leads to the secondary cooling system 18 curing the initial layer of plastic to its dry nature on its way towards the decorative confetti and glitter dispenser 20 where a uniform coat of decorative confetti and glitter drops onto the cured plastic coating the width of the belt. After being decorated, the belt travels to the wrap pressure wheel 22 being fed by the wrap supply wheel 24. At this stage the pressure wheel locks in air while shielding loose confetti and glitter from secondary molten plastic dispenser 26 distributing molten plastic over the wrap at temperatures high enough to bond the three layers but not melt the wrap and loose confetti and glitter in the bubble pockets and embedded between the layers of the film. Directly afterward, the bonded layers reach the final cooling systems 28 to drop the temperature before being spun off the conveyer belt and redirected to the packaging wheel (not shown).

### Method of Making Confetti Bubble Wrap

Manufacturing is accomplished by cooling a conveyer belt with thousands of indentations which will later create as the bubbles. As the belt begins traveling through the system, several cooling devices reduce the temperature of the belt in preparation to receive the molten plastic by blowing cool air over the top before reaching the molten plastic dispenser where a thin layer of molten plastic is evenly coated over the entire belt. Directly after the molten plastic dispenser, the belt continues under an additional cooling blower to eliminate pliability of the plastic before reaching the oncoming confetti and glitter point where an even layer of specific confetti and glitter drops evenly over the cured plastic leading it to the wrap feeding wheel and compression wheel where a thin sheet of plastic wrap is rolled over the cured decorative bubble wrap trapping in air and protecting the confetti and glitter from the next layer of molten plastic that is to follow. Once reaching the second molten machine a thin bottom layer of molten plastic is dispensed over the plastic wrap at a temperature high enough to bond all three layers together; this includes encasing the decorative pieces of confetti and glitter into the wrap excluding all confetti and glitter in the bubble sections due to the molten plastic not making contact with them due to the plastic wrap. Directly after the belt completes one final pass under the last cooling fan to reduce the temperature of the last layer of molten plastic before it has time to melt the plastic wrap and reach the confetti and glitter in each bubble. The bubble wrap is then pulled from the system and wound on a packaging wheel.

The bubble wrap of the present invention includes glitter or confetti, or both encapsulated into the bubbles. The bubble wrap of the present invention includes glitter or confetti, or both, embedded between the layers of film. One or both layers of plastic which comprise the bubble wrap can be colored, or printed to accentuate the holiday or event being celebrated.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. Bubble wrap comprising a clear or colored or printed top or bottom layer or printed top and bottom layers, and further comprising confetti or glitter, or both, injected into the bubbles of the bubble wrap.

2. The bubble wrap of claim 1 further comprising confetti or glitter, or both, injected into the bubbles of the bubble wrap.

3. The bubble wrap of claim 2 wherein the confetti is in the shapes of holiday themed objects.

4. The bubble wrap of claim 2 wherein the bubbles contain glitter.

5. The bubble wrap of claim 1 further comprising confetti or glitter or both embedded between the top layer and the bottom layer.

6. A method for making bubble wrap having glitter or confetti or both injected into the bubbles comprising:
a) having a continuous nonstick conveyer belt with thousands of indentations supported by several soft foam support wheels;
b) having a molten plastic film dispenser;
c) having an initial cooling system as the conveyer begins through the system lowering the temperature of the belt to expedite the solidifying of the molten plastic being dispensed evenly over the width of the forming belt from the molten plastic film dispenser;
d) coating the belt with molten plastic film;
e) leading the film to a secondary cooling system thereby curing the initial layer of plastic to its dry nature;
f) continuing the travel of film to the decorative confetti and glitter dispenser where a uniform coat of decorative confetti and glitter drops onto the cured plastic coating the width of the belt;
g) continuing the travel of the film to the wrap pressure wheel which is fed by a wrap supply wheel;
h) having a pressure wheel lock in air while shielding loose confetti and glitter from a secondary molten plastic dispenser distributing molten plastic over the wrap at temperatures high enough to bond the three layers but not melt the wrap and loose confetti and glitter in the bubble pockets;
i) continuing the travel of the bonded layers of wrap to a final cooling system to drop the temperature before being spun off the conveyer belt and redirected to the packaging wheel.
